(19) United States
(12) Patent Application Publication
(10) Pub. No.: US 2013/0310088 A1
(43) Pub. Date: Nov. 21, 2013

(54) SHORT MESSAGE SERVICE MOBILE ORIGINATED/MOBILE TERMINATED WITHOUT MOBILE STATION INTERNATIONAL SUBSCRIBER DIRECTORY NUMBER (MSISDN) IN INTERNET PROTOCOL MULTIMEDIA SUBSYSTEM (IMS) WITH INTER-PUBLIC LAND MOBILE NETWORK (PLMN) HANDLING

(71) Applicant: NOKIA SIEMENS NETWORKS OY, Espoo (FI)

(72) Inventors: Curt WONG, Sammamish, WA (US); Jari MUTIKAINEN, Lepsama (FI)

(73) Assignee: NOKIA SIEMENS NETWORKS OY, Espoo (FI)

(21) Appl. No.: 13/894,686

(22) Filed: May 15, 2013

Related U.S. Application Data
(60) Provisional application No. 61/647,019, filed on May 15, 2012.

(51) Int. Cl. H04W 4/14

(52) U.S. Cl. CPC H04W 4/14
USPC 455/466

(57) ABSTRACT

Methods and apparatuses for SMS delivery between user equipment without MSISDN is provided. One method includes sending a SIP message, which may include an SMS payload, to the IMS network where the destination UE is homed, and determining whether the destination UE is IMS registered. If the destination UE is not IMS registered, then the SIP message may be routed to a default gateway which will attempt to deliver the SIP message by querying the serving MSC/SGSN information from the HSS. The method may include receiving an indication that the destination UE is unavailable and receiving the IMSI or correlation ID of the destination UE. The method may further include submitting the SMS to SMSC-A with the IMSI (or correlation ID) of the destination UE. If, however, it is determined that the destination UE is IMS registered and the SIP message was delivered to the destination UE, then the method may include receiving an acknowledgement that delivery was successful.

### CROSS-REFERENCE TO RELATED APPLICATIONS

This application claims priority to U.S. Provisional Application Ser. No. 61/647,019 filed on May 15, 2012. The contents of this earlier filed application are hereby incorporated by reference in their entirety.

### BACKGROUND

1. Field

Embodiments of the invention generally relate to wireless communications networks, such as, but not limited to, the Universal Mobile Telecommunications System (UMTS) Terrestrial Radio Access Network (UTRAN) and/or Long Term Evolution (LTE) Evolved UTRAN (E-UTRAN).

2. Description of the Related Art

Universal Mobile Telecommunications System (UMTS) Terrestrial Radio Access Network (UTRAN) refers to a communications network including base stations, or Node Bs, and for example radio network controllers (RNC). UTRAN allows for connectivity between the user equipment (UE) and the core network. The RNC provides control functionalities for one or more Node Bs. The RNC and its corresponding Node Bs are called the Radio Network Subsystem (RNS). In case of E-UTRAN (enhanced UTRAN) no RNC exists and most of the RNC functionalities are contained in the eNodeB (enhanced Node B).

Long Term Evolution (LTE) or E-UTRAN refers to improvements of the UMTS through improved efficiency and services, lower costs, and use of new spectrum opportunities. In particular, LTE is a 3GPP standard that provides for uplink peak rates of at least 50 megabits per second (Mbps) and downlink peak rates of at least 100 Mbps. LTE supports scalable carrier bandwidths from 20 MHz down to 1.4 MHz and supports both Frequency Division Duplexing (FDD) and Time Division Duplexing (TDD).

As mentioned above, LTE is also expected to improve spectral efficiency in 3G networks, allowing carriers to provide more data and voice services over a given bandwidth. Therefore, LTE is designed to fulfill future needs for high-speed data and media transport in addition to high-capacity voice support. Advantages of LTE are, for example, high throughput, low latency, FDD and TDD support in the same platform, an improved end-user experience, and a simple architecture resulting in low operating costs.

Further releases of 3GPP LTE (e.g., LTE Rel-10, LTE-Rel-11) are targeted towards future international mobile telecommunications advanced (IMT-A) systems, referred to herein for convenience simply as LTE-Advanced (LTE-A).

LTE-A is directed toward extending and optimizing the 3GPP LTE radio access technologies. A goal of LTE-A is to provide significantly enhanced services by means of higher data rates and lower latency with reduced cost. LTE-A will be a more optimized radio system fulfilling the international telecommunication union-radio (ITU-R) requirements for IMT-Advanced while keeping the backward compatibility.

The internet protocol (IP) multimedia subsystem (IMS) is an architectural framework for delivering IP multimedia services. In order to facilitate integration with the Internet, IMS uses internet engineering task force (IETF) protocols, such as session initiation protocol (SIP), wherever possible. IMS is designed to assist in the access of voice and multimedia applications from wireless terminals or devices.

### SUMMARY

One embodiment is directed to a method including sending, by a gateway, a session initiation protocol (SIP) message to an internet protocol multimedia subsystem (IMS) network where a destination user equipment (UE) is homed. The session initiation protocol (SIP) message comprises a short message service (SMS) payload, and the destination user equipment (UE) does not have a mobile station international subscriber directory number (MSISDN). The method may further include determining whether the destination user equipment (UE) is registered to the internet protocol multimedia subsystem (IMS) network.

Another embodiment is directed to an apparatus including at least one processor and at least one memory comprising computer program code. The at least one memory and the computer program code are configured, with the at least one processor, to cause the apparatus at least to send a session initiation protocol (SIP) message to an internet protocol multimedia subsystem (IMS) network where a destination user equipment (UE) is homed. The session initiation protocol (SIP) message comprises a short message service (SMS) payload, and the destination user equipment (UE) does not have a mobile station international subscriber directory number (MSISDN). The at least one memory and the computer program code may also be configured, with the at least one processor, to cause the apparatus at least to determine whether the destination user equipment (UE) is registered to the internet protocol multimedia subsystem (IMS) network.

Another embodiment is directed to a computer program, embodied on a non-transitory computer readable medium. The computer program is configured to control a processor to perform a process. The process includes sending a session initiation protocol (SIP) message to an internet protocol multimedia subsystem (IMS) network where a destination user equipment (UE) is homed. The session initiation protocol (SIP) message comprises a short message service (SMS) payload, and the destination user equipment (UE) does not have a mobile station international subscriber directory number (MSISDN). The process may further include determining whether the destination user equipment (UE) is registered to the internet protocol multimedia subsystem (IMS) network.

Another embodiment is directed to a method including receiving, by a gateway, a session initiation protocol (SIP) message from a sending user equipment (UE) via an originating gateway. The session initiation protocol (SIP) message comprises a short message service (SMS) payload, and a destination user equipment (UE) for the SMS payload does not have a mobile station international subscriber directory number (MSISDN). The method may also include determining whether the destination user equipment (UE) is registered to the internet protocol multimedia subsystem (IMS) network.

Another embodiment is directed to an apparatus including at least one processor and at least one memory comprising computer program code. The at least one memory and the computer program code are configured, with the at least one processor, to cause the apparatus at least to receive a session initiation protocol (SIP) message from a sending user equipment (UE) via an originating gateway. The session initiation protocol (SIP) message comprises a short message service (SMS) payload, and a destination user equipment (UE) for the SMS payload does not have a mobile station international subscriber directory number (MSISDN). The at least one memory and the computer program code may also be configured, with the at least one processor, to cause the apparatus at least to determine whether the destination user equipment (UE) is registered to the internet protocol multimedia subsystem (IMS) network.

Another embodiment is directed to a computer program, embodied on a non-transitory computer readable medium. The computer program is configured to control a processor to perform a process. The process includes receiving, by a gateway, a session initiation protocol (SIP) message from a sending user equipment (UE) via an originating gateway. The session initiation protocol (SIP) message comprises a short message service (SMS) payload, and a destination user equipment (UE) for the SMS payload does not have a mobile station international subscriber directory number (MSISDN). The process may also include determining whether the destination user equipment (UE) is registered to the internet protocol multimedia subsystem (IMS) network.

### BRIEF DESCRIPTION OF THE DRAWINGS

For proper understanding of the invention, reference should be made to the accompanying drawings, wherein:

FIG. 1 illustrates a signaling diagram according to an embodiment;

FIG. 2 illustrates a signaling diagram according to another embodiment;

FIG. 3 illustrates a signaling diagram according to another embodiment;

FIG. 3a illustrates a signaling diagram according to another embodiment;

FIG. 4 illustrates a signaling diagram according to another embodiment;

FIG. 5 illustrates a signaling diagram according to another embodiment;

FIG. 6 illustrates an apparatus according to an embodiment;

FIG. 7 illustrates a flow diagram of a method according to one embodiment; and

FIG. 8 illustrates a flow diagram of a method according to another embodiment.

### DETAILED DESCRIPTION

It will be readily understood that the components of the invention, as generally described and illustrated in the figures herein, may be arranged and designed in a wide variety of different configurations. Thus, the following detailed description of the embodiments of systems, methods, apparatuses, and computer program products for SMS delivery without MSISDN as represented in the attached figures, is not intended to limit the scope of the invention, but is merely representative of selected embodiments of the invention.

If desired, the different functions discussed below may be performed in a different order and/or concurrently with each other. Furthermore, if desired, one or more of the described functions may be optional or may be combined. As such, the following description should be considered as merely illustrative of the principles, teachings and embodiments of this invention, and not in limitation thereof.

Short message service (SMS) delivery over the internet protocol (IP) multimedia subsystem (IMS) has been specified since 3GPP Release 7 with TS 23.204. The routing of SMS, even for IMS devices, is still based on mobile station international subscriber directory number (MSISDN). As a result, the SMS over IP architecture defined in TS 23.204 requires the use of recipient's MSISDN in order to route the SMS properly. The sender's MSISDN is also needed in order for the recipient's device to identify the sender and for replying back to this SMS.

In 3GPP Release 11, the 3GPP began a study, in TR 23.863, on how to support SMS in IMS without MSISDN. One topic in this study is the communication via SMS between MSISDN-less IMS user equipment (UEs). Without MSISDN, the “SMS over IP” requires some fundamental changes to routing, functional node behavior, and the devices' procedure. Therefore, embodiments of the invention are related to SMS delivery without the use of MSISDN.

In TR 23.863, there is one alternative proposed in section 5.2.1 for “Direct delivery with IP-SM-GW interworking.” In summary, the following ideas are proposed in that solution:

1. The sending user equipment (UE) embeds its sender's SIP-URI and recipient's SIP-URI within the SMS payload.

2. In the SMS protocol level the sending UE fills the transfer protocol destination address (TP-DA) with a pre-defined “MT short code” for indicating to the internet protocol short message gateway (IP-SM-GW) that the destination UEs identity is in the SMS payload, the routing protocol originating address (RP-OA) is filled with a pre-defined “MO short code” for indicating to the IP-SM-GW that the sending UE's identity is in the SMS payload.

3. The IP-SM-GW retrieves the destination UE's session initiation protocol uniform resource identity (SIP-URI) from the SMS payload and queries the HSS for routing to terminating S-CSCF.

4. The IP-SM-GW fills in the RP-OA and TP-OA with its own address and sends the SIP MESSAGE with R-URI and To headers=destination UE's SIP URI to the terminating S-CSCF.

5. The terminating device parses the SMS payload and finds the sending UE's SIP URI and uses that for SMS reply.

The above-described procedure, however, has several disadvantages. For example, the SMS payload effectively becomes much smaller (e.g., 160 characters−sender's+recipient's SIP URI). This could affect charging as one SMS may now require splitting into multiple parts (i.e., SMS segmentation). Another disadvantage is that the pre-defined short code needs to be provisioned to the UE. Interworking with NAS based SMS is missing. Storing and forwarding is also not supported unless more impact is done to IP-SM-GW. It should be noted that storing and forwarding is functionality provided by SMSC that is not utilized by this proposal.

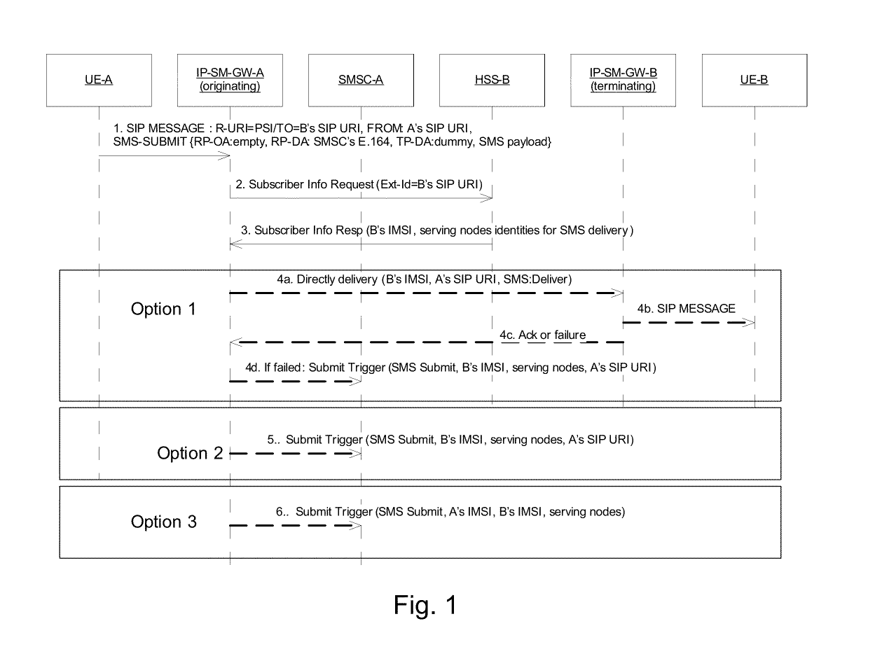

Another solution is described in TR 23.863, subclause 5.2.2, but has the disadvantage that it is only workable if both the sending UE and the destination UE belong to the same public land mobile network (PLMN). This is because the operator does not want their HSS to be queried by external entities for SMS purposes. FIG. 1 illustrates an example of this type of solution.

In particular, FIG. 1 illustrates a signaling diagram for submitting a SMS from a sending device (UE-A), according to an embodiment. As illustrated in FIG. 1, at step 1, IP-SM-GW-A is included as part of the 3rd party registration. The IP-SM-GW-A is aware that a party does not have a MSISDN, and it stores UE-A's SIP-URI (IMPU, IMS public user identity) and IMPI (IMS private user identity) or international mobile subscriber identity (IMSI) it received from the S-CSCF as part of 3rd party registration. If IP-SM-GW-A did not receive IMPU/IMSI and/or SIP-URI as part of the 3rd party registration procedure, it can query the HSS of UE-A to obtain these information. UE-A constructs a mobile originated SMS (MO-SMS) and the MO-SMS is delivered to the IP-SM-GW-A based on existing procedures. Since the receiving device (UE-B) does not have a MSISDN, the UE-A fills the TP-DA field with a dummy value (e.g., 000000s). UE-A sets the R-URI to public service identity (PSI) (short message service center (SMSC) address) and sets the To header to UE-B's SIP-URI in the MESSAGE. The proxy call session control function (P-CSCF) fills the default URI of UE-A to p-asserted-identity before sending the MESSAGE to the serving call session control function S-CSCF. Since, in this embodiment, the UE-A does not have a MSISDN, it also does not have a tel URI and, therefore, the default URI is UE-A's SIP URI. The S-CSCF executes the iFC and forwards the MESSAGE to the IP-SM-GW-A.

As further illustrated in FIG. 1, at step 2, the IP-SM-GW-A retrieves the SIP URI for UE-B from the To Header. The IP-SM-GW-A queries the home subscriber server (HSS) of UE-B (HSS-B) for UE-B's IMSI and SMS routing info. Essentially, the “Subscriber Info Request” message defined in TS 23.682 may be reused for machine type triggering message between the HSS and machine type communication interworking function (MTC-IWF) with the clarification that the external identity which is defined in TS 23.682, is a device specific identifier, is here set to contain the IMS public user identity (IMPU), i.e. SIP URI. Therefore when the IP-SM-GW queries the HSS with B′ SIP URI as an external identifier for UE-B, the HSS returns the IMSI-B. Then, at step 3, the HSS returns UE-B's IMSI and its current serving node for SMS delivery to UE-B.

According to one embodiment, as shown in option 1 of FIG. 1, the policy allows the IP-SM-GW-A to directly deliver the SMS to UE-B via IP-SM-GW-B. In step 3 discussed above, the IP-SM-GW-A detects that the TP-DA has a dummy value and that the To header contains a SIP URI, therefore, in step 4a, the IP-SM-GW-A may attempt a direct delivery via IMS domain, without going to SMSC at first. The IP-SM-GW-A is aware of the address of IP-SM-GW-B based on the step 3. The IP-SM-GW-A constructs a SIP MESSAGE with {p-asserted-identity:A's SIP-URI, To:B's SIP-URI, R-URI=IP-SM-GW-B, SMS Deliver} {TP-OA=dummy, RP-OA=IP-SM-GW-A, RP-DA=B's IMSI, sms payload}. In step 4b, the IP-SM-GW-B adds its own URI to the topmost p-asserted-identity, to ensure the UE-B sends the delivery report to the IP-SM-GW-B. The IP-SM-GW-B delivers the SIP MESSAGE to UE-B by using the UE-B's SIP URI, which it received in the To header field. UE-B stores and removes the topmost URI in p-asserted-identity, and uses it as an R-URI for a delivery report. The remaining URIs in the p-asserted-identity contains the UE-A's SIP URI. If UE-B is not reachable via IMS, the IP-SM-GW-B may attempt the delivery via circuit switched (CS) or Serving GPRS Support Node (SGSN). This is based on current procedure, except that the IP-SM-GW needs to convert the UE-B's SIP URI to IMSI-B via a HSS query.

In step 4c, a success or failure notice is sent back to IP-SM-GW-A. The UE-B may be temporarily out of coverage or the memory may be full, which would result in a failure of delivery. In step 4d, the IP-SM-GW-A submits this SMS to UE-A's SMSC for storing and forwarding function.

According to some embodiments, such as options 2 or 3 illustrated in FIG. 1, it is assumed that direct delivery is not allowed so that signaling must go through the SMSC first. For example, the IP-SM-GW-A submits the SMS to SMSC-A. In one embodiment, the IP-SM-GW-A reuses the Submit Trigger defined in TS 23.682 for machine type triggering message between the SMSC and MTC-IWF (T4 reference point), along with the new addition for option 2 (step 5) in which the UE-A's SIP URI is also included. For option 3, as shown in step 6, only the UE-A's IMSI is included, and no enhancements to T4 are required.

Currently, steps 2 and 3 of FIG. 1 are only be possible if the destination UE (UE-B) is also a subscriber under the same operator as the sending UE (UE-A) because principle used for MTC-IWF-HSS query defined in TS 23.682 is mainly defined as intra operator interface. The solution to allow SMS delivery to UE-B from other operator is FFS.

Embodiments of the invention are able to enhance the solution discussed above to allow inter-PLMN delivery of SMS without requiring the destination UE to be subscribed to the same operator as the sending UE. Further, embodiments of the invention can also be used for SMS delivery within the same PLMN, where the receiving UE and sending UE are subscribed to the same operator, for example. Accordingly, embodiments can be used for both inter-PLMN delivery and intra-PLMN delivery.

Embodiments of the invention may achieve the objectives discussed above according to the following steps:

1. The IP-SM-GW-A sends the SIP message over to IMS network where the destination UE-B is homed.

2. If the UE-B is not IMS registered, then embodiments follow TR 23.228—“Mobile Terminating call procedures to unregistered Public User Identity that has services related to unregistered state”—so that the SIP MESSAGE is routed to a S-CSCF then to a default IP-SM-GW-B. At that point, IP-SM-GW-B may try to deliver the message via MSS or SGSN by querying the serving MSC/SGSN info from HSS.

3. The IP-SM-GW-B queries the HSS for IMSI or “correlation ID” on B-party, set the notification flag for SMS when UE is available, and indicate to HSS to store the SMSC address and public identity of party A. The IP-SM-GW-B then returns the indication back to the IP-SM-GW-A that the UE is unavailable, and also returns the IMSI or “correlation ID” of B. The usage of “correlation ID” is described in detail below.

4. The IP-SM-GW-A submits this SMS to SMSC-A with UE-B's IMSI or correlation ID and the indication that UE-B's party is out of reach.

5. When UE-B is IMS registered then the HSS informs SMSC-A that it is now available for delivery.

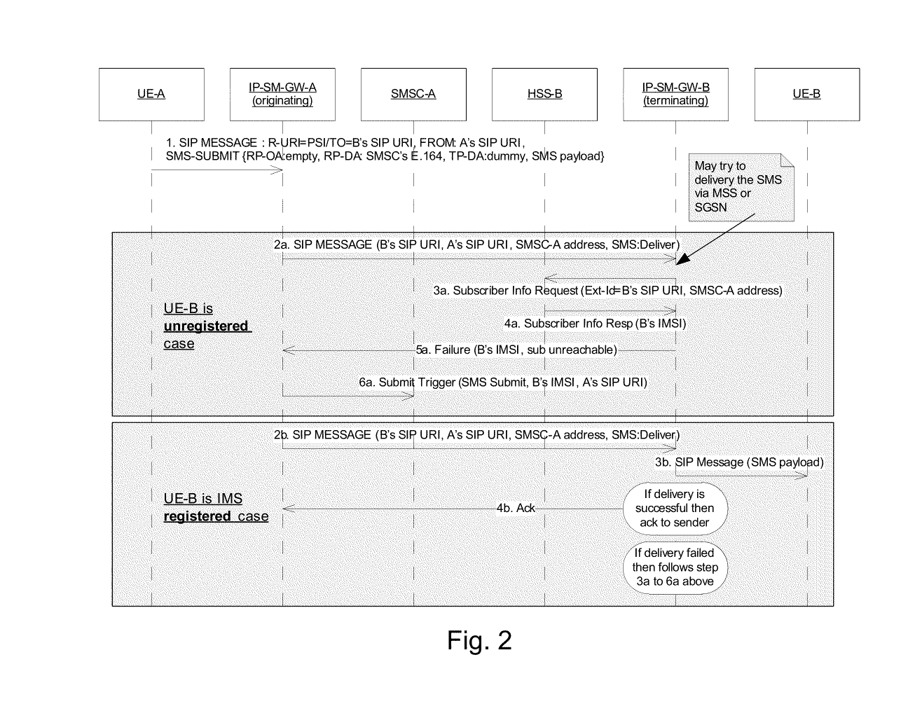

FIG. 2 illustrates a signaling diagram for SMS delivery from MSISDN-less UE to MSISDN-less UE, according to one embodiment. As illustrated in FIG. 2, at step 1, UE-A is IMS registered and IP-SM-GW-A has been included as part of 3rd party registration. UE-A constructs a MO-SMS and delivers it to IP-SM-GW-A based on existing procedures. Since UE-B does not have a MSISDN, the UE-A fills the TP-DA field with a dummy value (e.g., 000000s). UE-A sets the R-URI to PSI (SMSC address) and the To header with UE-B's SIP URI in the MESSAGE. Based on the existing procedure, P-CSCF fills the UE-A's default URI to p-asserted-identity before sending the MESSAGE to S-CSCF and S-CSCF executes the iFC and forwards the MESSAGE to IP-SM-GW-A. At step 2a, the SIP MESSAGE arrives to the IMS network of UE-B. The UE-B is not IMS registered and the message is routed to S-CSCF then to an IP-SM-GW-B using the procedure defined in TS 23.228 for “Mobile Terminating call procedures to unregistered Public User Identity that has services related to unregistered state”. IP-SM-GW-B is aware that the UE-B is unreachable and may try to deliver the SMS via SGSN or MSC. This can be done by querying the HSS for the current serving MSC and SGSN address, for example.

At steps 3a/4a, the IP-SM-GW-B is aware that UE-B is not reachable in IMS and is not trying to deliver via MSC or SGSN so it sets the message waiting flag and SMSC-A address in HSS, and retrieves UE-B's IMSI. At step 5a, the IP-SM-GW-B returns a negative ack to IP-SM-GW-A, and indicates that UE-B is unreachable along with UE-B's IMSI. At step 6a, the IP-SM-GW-A submits the SMS toward SMSC-A with an indication that UE-B is unreachable along with B's IMSI.

At steps 2b/3b, the SIP MESSAGE arrives to the IMS network of the UE-B. The UE-B is IMS registered so this message is routed to IP-SM-GW-B that is serving the UE-B. The IP-SM-GW-B then tries to deliver the SMS to UE-B. At step 4b, if the message is successfully delivered to the UE-B, then an ack is sent back to the IP-SM-GW-A. If the message delivery fails (e.g., the UE is out of coverage), then the IP-SM-GW-B follows step 3a to 6a, and the IP-SM-GW-A will then submit the SMS to SMSC-A for storing and forwarding.

According to one embodiment, in the SMS router functionality of the IP-SM-GW, the IMSI can be hidden by using “correlation ID”. This has the advantage of privacy (i.e, terminating network does not want the originating network to know the real IMSI of UE-B and the originating network does not want the terminating network to know the IMSI of UE-A). In addition, this “correlation ID” can be used to filter out the spammer by removing those terminating SMS with the unknown “correlation ID”.

This feature can also be applied to the embodiment illustrated in FIG. 2 discussed above. In order to do so, at step 3a, the IP-SM-GW-B indicates the UE-A's public identity (SIP URI) to HSS and at 4a, the HSS allocates a “correlation ID” and returns this to the IP-SM-GW-B instead of returning the UE-B's IMSI. One example of how the HSS can allocate this “correlation ID” is by employing a temporary IMSI for each real IMSI. The real IMSI is the root key to the subscription. The temporary IMSI can be changed over time and is only associated with the real IMSI when there is a message waiting flag active in the subscription data. The correlation ID can be in the form of mobile country code (MCC)+mobile network code (MNC)+SMS ID (e.g., 123456789) or it can also take the form of SIP URI (e.g., sip:234150999999999@ims.mnc015.mcc234.3gppnetwork.org).

When the IP-SM-GW (acting as SMS router) receives the “correlation ID” from the SMSC-A via forwardSMS operation, it queries the HSS to retrieve the sender and receiver identities (SIP-URI of A and B) and the current serving IP-SM-GW and forwards the SMS as a SIP MESSAGE toward the serving IP-SM-GW for SMS termination.

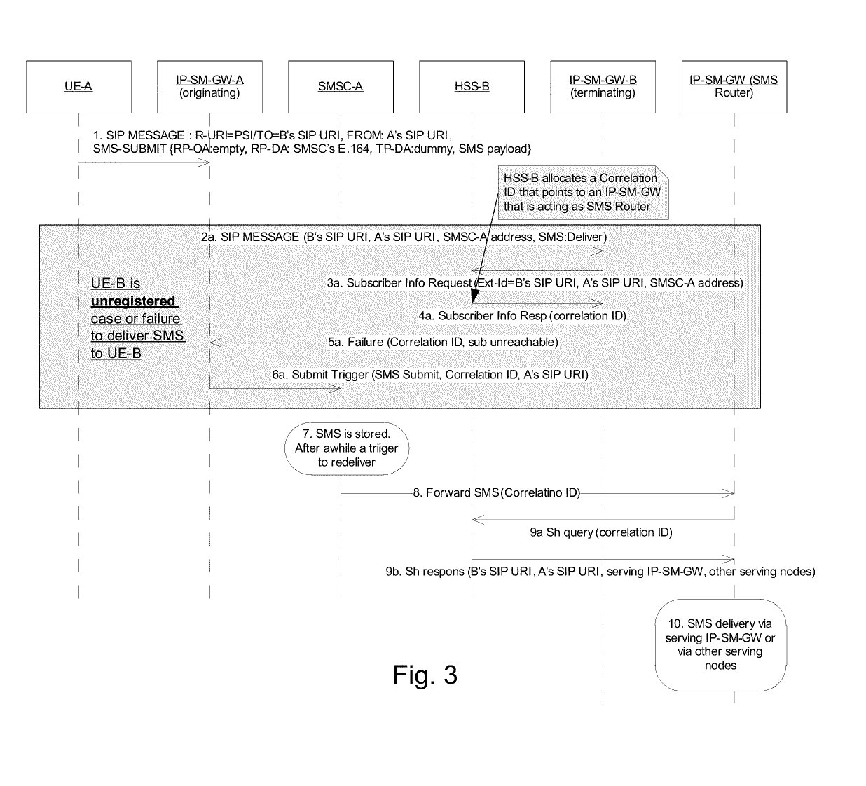

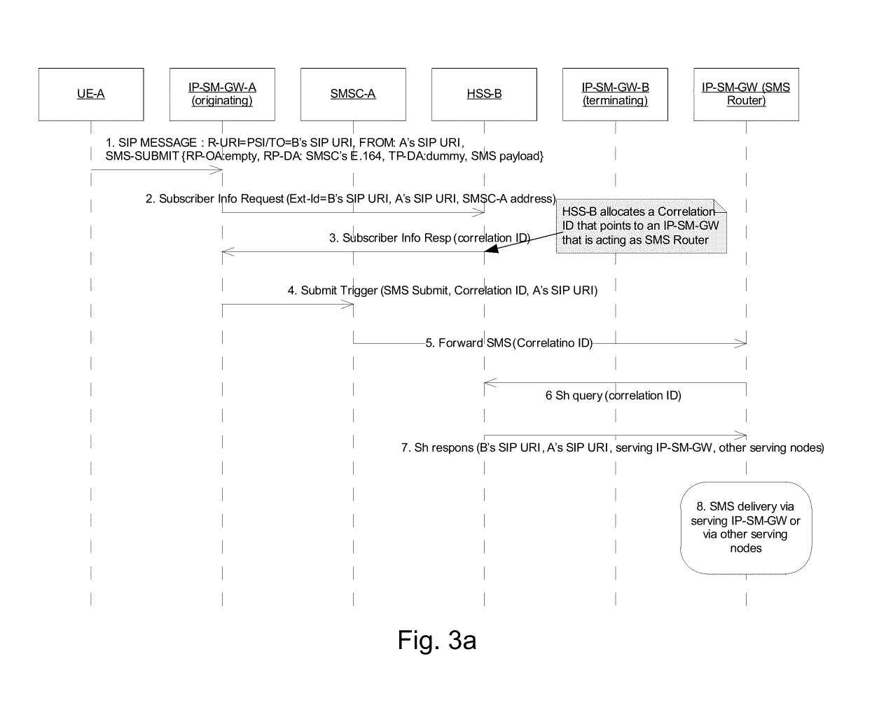

FIG. 3 illustrates an example of a signaling diagram utilizing the “correlation ID,” according to one embodiment. More specifically, FIG. 3 illustrates an example of MSISDN-less UE to MSISDN-less UE SMS submit using a correlation ID technique, according to an embodiment. Steps 1-6 of FIG. 3 are similar to those of FIG. 2 discussed above, with the exception that the correlation ID is used instead of the real IMSI of the destination UE-B and originating UE-A. Step 7 corresponds to the existing storing functionality in the SMSC, and the forwarding of SMS functionality. At step 8, the routing of forward SMS operation is based on correlation ID and it goes to a destinated IP-SM-GW which is acting as SMS Router. At step 9, the SMS Router queries the HSS to ensure the Correlation ID is valid and HSS returns the corresponding UE-B's SIP URI and UE-A's SIP URI along with the current serving nodes (i.e., registered IP-SM-GW of UE-B, and possibly the current serving MSC/SGSN information). At step 10, the SMS Router uses the B's SIP URI and the serving IP-SM-GW (if IMS registered) to deliver the SMS to the terminating UE-B.

FIG. 3a illustrates another example of a signaling diagram utilizing the “correlation ID,” according to one embodiment. More specifically, FIG. 3a illustrates an example of MSISDN-less UE to MSISDN-less UE SMS submit using a correlation ID technique, according to an embodiment. Steps 1 of FIG. 3a is the same as to those of FIG. 2 discussed above. At step 2, IP-SM-GW-A queries the HSS-B for correlation ID similar to step 3a and 3b of FIG. 3. At step 4, IP-SM-GW-A submits the SMS as in step 6a of FIG. 3 so the SMSC-A can deliver the SMS as in step 8-10 of FIG. 3.

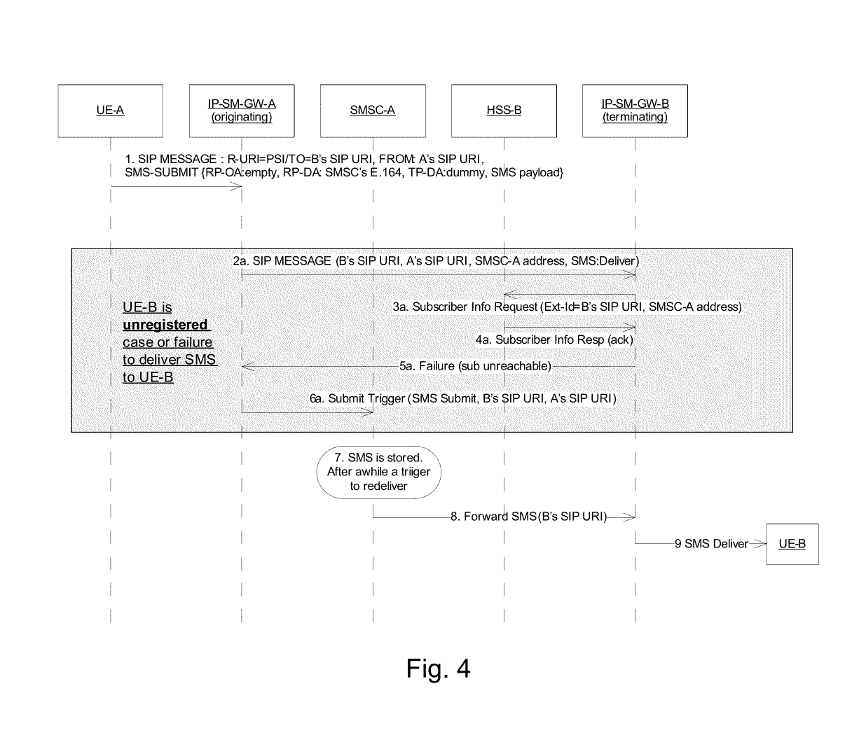

FIG. 4 illustrates a signaling diagram according to another embodiment in which enhanced protocol is used between SMSC and IP-SM-GW-B for forwardSMS. This embodiment avoids the use of UE-B's IMSI or correlation ID in the originating network by enhancing the forwardSMS operation to allow the UE-B's SIP-URI to be used. For example, the MAP operation may be carried out using Diameter protocol and it carries the UE-B's SIP URI. This aspect is illustrated in steps 6a and 8 of FIG. 4. The disadvantage of this option compared to the use of “correlation ID” is that the terminating network cannot perform spam filtering with the SMS forwarded by SMSC.

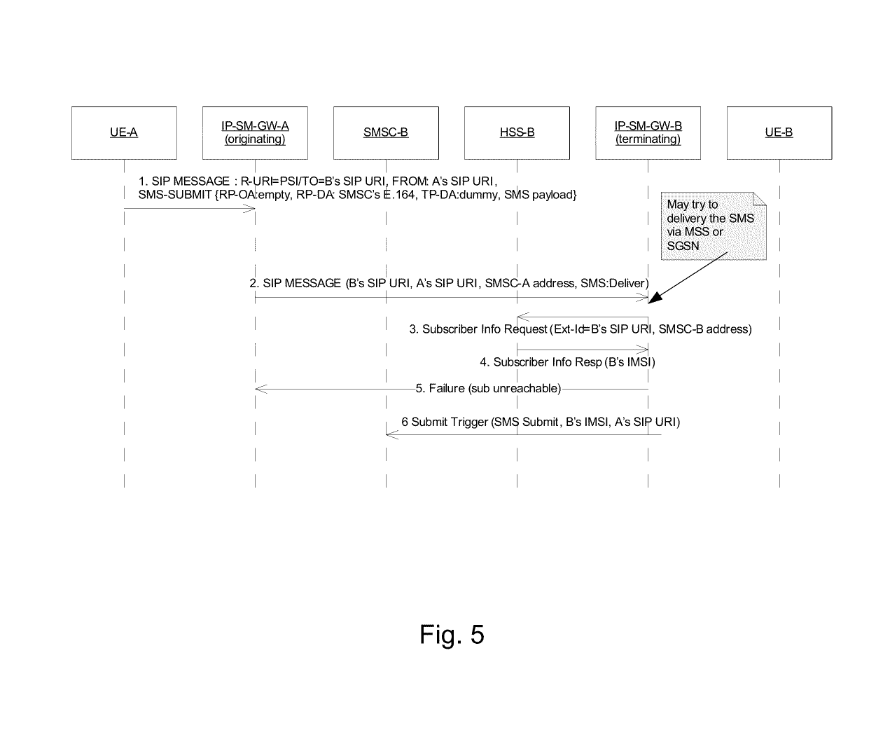

Another alternative is to re-use the Submit Trigger (T4 reference point) defined in TS 23.682, and deliver the MT SM via the SMSC-B, in a case that the attempt to deliver via IMS, CS, or PS (SGSN) fails, such as when the UE-B is offline. This embodiment is illustrated in the signaling diagram of FIG. 5.

As illustrated in FIG. 5, steps 1 and 2 are the same as those illustrated in FIG. 2 discussed above. At step 3, in case the MT SM delivery fails over IMS (e.g., UE-B is not IMS registered), the IP-SM-GW-B may attempt to deliver via CS and/or SGSN. If none of these succeed, then the IP-SM-GW-B needs to forward the MT SM to the SMSC-B, in a similar manner as the IWF sends the trigger to SMSC over the T4 reference point. For this, the IP-SM-GW-B converts the SIP-URI-B (external ID) to IMSI-B via the HSS, in a similar manner as the IWF does.

Continuing with FIG. 5, at step 4, the HSS returns the IMSI-B. At step 5, the IP-SM-GW-B responds to the IP-SM-GW-A that the delivery failed. In one embodiment, the response may contain additional information that the IP-SM-GW-B will deliver the message to the SMSC-B, so that IP-SM-GW-A knows it does not send the same message to SMSC-A. At step 6, the SMS is submitted to the SMSC-B. The SMSC-B then delivers the MT SM as in the current specifications. This means the SMSC-B queries the HSS for SM routing information, etc.

This embodiment, as illustrated in FIG. 5, may have charging implications as the SMSC-A is not part of the MT SM delivery so it is not possible to apply the charging in SMSC-A. On the other hand, the same issue applies also any model which delivers the SM directly via IMS, and to T4 in TS 23.682. In these cases, the charging is based on the CDR generated from the terminating network.

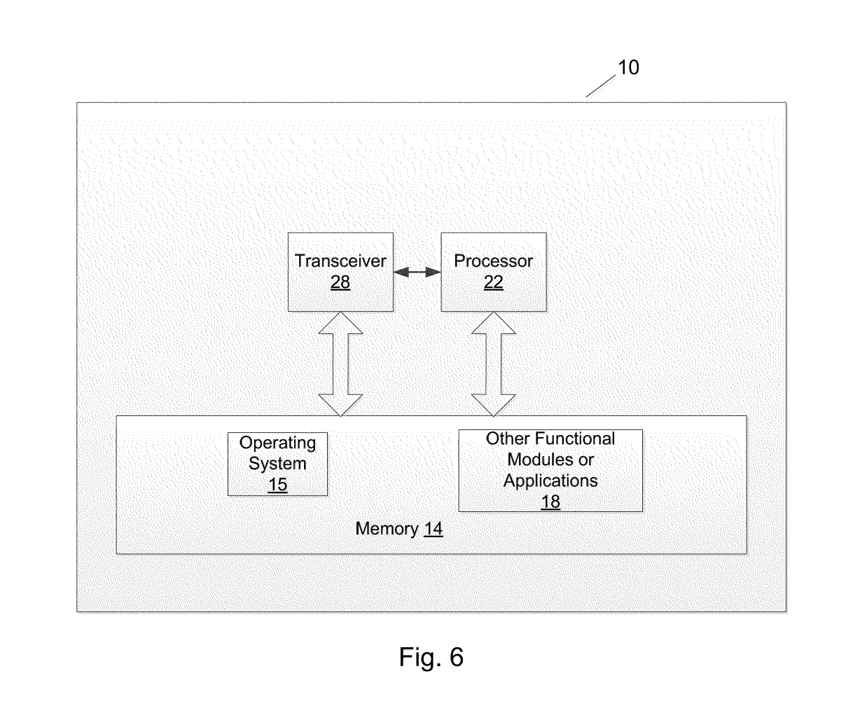

FIG. 6 illustrates an apparatus 10 according to an embodiment. In one embodiment, apparatus 10 may be network element, such as a gateway, service center, control function, subscription server, etc. In other embodiments, apparatus 10 may be a mobile device such as user equipment (UE). It should be noted that FIG. 6 does not necessarily illustrates all components of apparatus 10. Only those components necessary for understanding embodiments of the invention are illustrated, but one of ordinary skill in the art would understand that apparatus 10 may include additional components that are not illustrated.

Apparatus 10 includes a processor 22 for processing information and executing instructions or operations. Processor 22 may be any type of general or specific purpose processor. While a single processor 22 is shown in FIG. 6, multiple processors may be utilized according to other embodiments. In fact, processor 22 may include one or more of general-purpose computers, special purpose computers, microprocessors, digital signal processors (“DSPs”), field-programmable gate arrays (“FPGAs”), application-specific integrated circuits (“ASICs”), and processors based on a multi-core processor architecture, as examples.

Apparatus 10 further includes a memory 14, coupled to processor 22, for storing information and instructions that may be executed by processor 22. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 14 can be comprised of any combination of random access memory (“RAM”), read only memory (“ROM”), static storage such as a magnetic or optical disk, or any other type of non-transitory machine or computer readable media. The instructions stored in memory 14 may include program instructions or computer program code that, when executed by processor 22, enable the apparatus 10 to perform tasks as described herein.

Apparatus 10 may also include one or more antennas (not shown) for transmitting and receiving signals and/or data to and from apparatus 10. Apparatus 10 may further include a transceiver 28 that modulates information on to a carrier waveform for transmission by the antenna(s) and demodulates information received via the antenna(s) for further processing by other elements of apparatus 10. In other embodiments, transceiver 28 may be capable of transmitting and receiving signals or data directly.

Processor 22 may perform functions associated with the operation of apparatus 10 including, without limitation, precoding of antenna gain/phase parameters, encoding and decoding of individual bits forming a communication message, formatting of information, and overall control of the apparatus 10, including processes related to management of communication resources.

In an embodiment, memory 14 stores software modules that provide functionality when executed by processor 22. The modules may include an operating system 15 that provides operating system functionality for apparatus 10. The memory may also store one or more functional modules 18, such as an application or program, to provide additional functionality for apparatus 10. The components of apparatus 10 may be implemented in hardware, or as any suitable combination of hardware and software.

In one embodiment, apparatus 10 may be the IP-SM-GW-A illustrated in FIGS. 1-5 discussed above. In this embodiment, apparatus 10 may be controlled by memory 14 and processor 22 to send, via transceiver 28, an SIP message, which may include an SMS payload, to the IMS network where the destination UE (i.e., the UE that is the intended recipient of the SMS) is homed. If the destination UE is not IMS registered, then the SIP message may be routed to a S-CSCF then to a default IP-SM-GW-B which will attempt to deliver the SIP message via MSS or SGSN by querying the serving MSC/SGSN information from the HSS. Additionally, apparatus 10 may be controlled by memory 14 and processor 22 to receive an indication that the destination UE is unavailable and also receive the IMSI or correlation ID of the destination UE. Apparatus 10 may then be controlled by memory 14 and processor 22 to submit the SMS to SMSC-A with the IMSI (or correlation ID) of the destination UE. If, however, the destination UE is IMS registered and the SIP message was delivered to the destination UE, then apparatus 10 may be controlled by memory 14 and processor 22 to receive an acknowledgement that delivery was successful.

In another embodiment, apparatus 10 may be the IP-SM-GW-B illustrated in FIGS. 1-5 discussed above. In this embodiment, apparatus 10 may be controlled by memory 14 and processor 22 to receive, via transceiver 28, an SIP message, which may include an SMS payload. The SIP message may be received from a sending UE (i.e., the UE sending the SMS) via an originating GW. When the destination UE (i.e., the UE that is the intended recipient of the SMS) is not IMS registered, apparatus 10 may be controlled by memory 14 and processor 22 to attempt to deliver the SIP message via MSS or SGSN by querying the serving MSC/SGSN information from the HSS. In addition, apparatus 10 may be controlled by memory 14 and processor 22 to query the HSS for the IMSI of the destination UE. In certain embodiments, apparatus 10 may be further controlled by memory 14 and processor 22 to set a notification flag for SMS when the destination UE becomes available, to indicate to the HSS to store the SMSC address of the sending UE, and to send an indication to the originating GW that the destination UE is unavailable. The indication may include the IMSI or correlation ID of the destination UE. If, however, the destination UE is IMS registered and the SIP message was delivered to the destination UE, then apparatus 10 may be controlled by memory 14 and processor 22 to send an acknowledgement that delivery was successful to the originating GW.

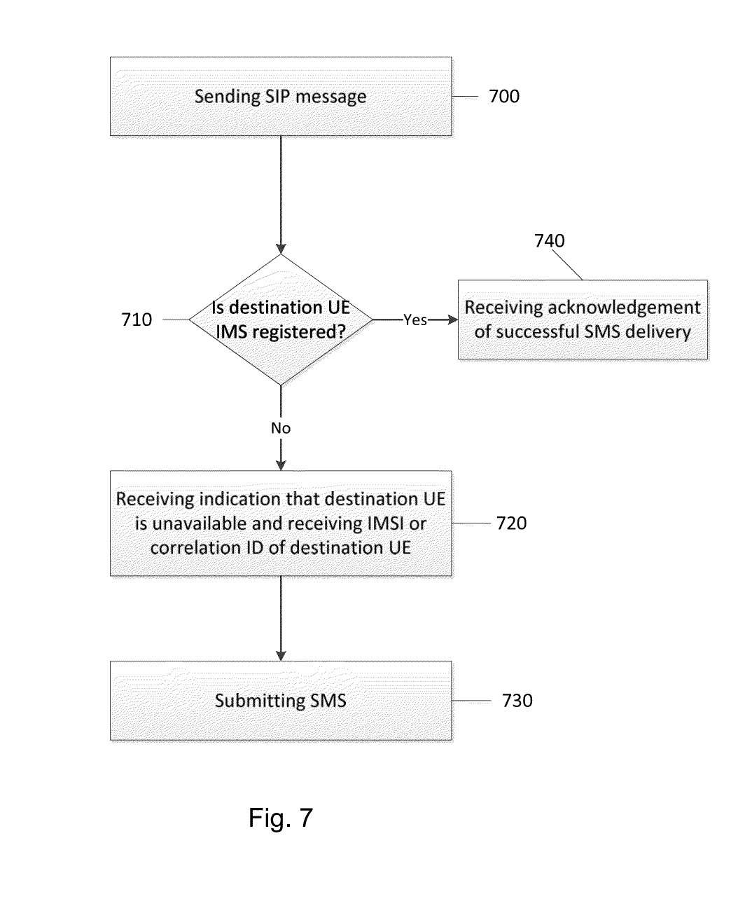

FIG. 7 illustrates a flow diagram of a method for SMS delivery between UEs without a MSISDN, according to one embodiment. The method includes, at 700, sending a SIP message, which may include an SMS payload, to the IMS network where the destination UE is homed. At 710, the method may include determining whether the destination UE is IMS registered. If the destination UE is not IMS registered, then the SIP message may be routed to a S-CSCF then to a default IP-SM-GW-B which will attempt to deliver the SIP message via MSS or SGSN by querying the serving MSC/SGSN information from the HSS. Additionally, at 720, the method may include receiving an indication that the destination UE is unavailable and also receiving the IMSI or correlation ID of the destination UE. At 730, the method may include submitting the SMS to SMSC-A with the IMSI (or correlation ID) of the destination UE. If, however, it is determined that the destination UE is IMS registered and the SIP message was delivered to the destination UE, then the method may include, at 740, receiving an acknowledgement that delivery was successful.

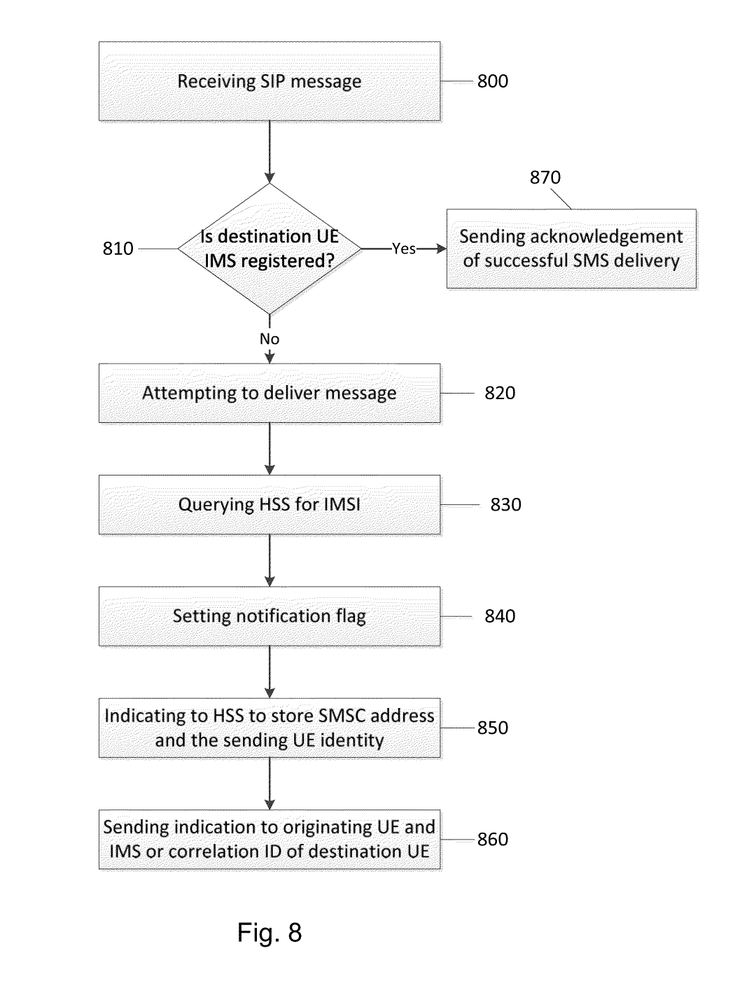

FIG. 8 illustrates a flow diagram of a method for SMS delivery between UEs without a MSISDN, according to another embodiment. The method includes, at 800, receiving an SIP message that may include an SMS payload. In an embodiment, the SIP message may be received from a sending UE via an originating GW. At 810, the method may include determining whether the destination UE is IMS registered. When the destination UE is not IMS registered, the method may include, at 820, attempting to deliver the SIP message via MSS or SGSN by querying the serving MSC/SGSN information from the HSS. In addition, at 830, the method may include querying the HSS for the IMSI of the destination UE. In certain embodiments, the method may include, at 840, setting a notification flag for SMS when the destination UE becomes available. At 850, the method may include indicating to the HSS to store the SMSC address of the sending UE and sending UE identity, and, at 860, sending an indication to the originating GW that the destination UE is unavailable. The indication may include the IMSI or correlation ID of the destination UE. If, however, it is determined that the destination UE is IMS registered and the SIP message was delivered to the destination UE, then the method may include, at 870, sending an acknowledgement that delivery was successful to the originating GW.

In some embodiments, the functionality of any of the methods described herein may be implemented by software and/or computer program code stored in memory or other computer readable or tangible media, and executed by a processor. In other embodiments, the functionality may be performed by hardware, for example through the use of an application specific integrated circuit (ASIC), a programmable gate array (PGA), a field programmable gate array (FPGA), or any other combination of hardware and software.

The described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. A method, comprising:
sending, by a gateway, a session initiation protocol (SIP) message to an internet protocol multimedia subsystem (IMS) network where a destination user equipment (UE) is homed,
wherein the session initiation protocol (SIP) message comprises a short message service (SMS) payload, and wherein the destination user equipment (UE) does not have a mobile station international subscriber directory number (MSISDN); and
determining whether the destination user equipment (UE) is registered to the internet protocol multimedia subsystem (IMS) network.

2. The method according to claim 1, wherein, when it is determined that the destination UE is IMS registered, the SIP message is delivered to the destination UE, and the method further comprises:
receiving an acknowledgement that delivery to the destination UE was successful.

3. The method according to claim 1, wherein, when it is determined that the destination UE is not IMS registered, the method further comprises:
routing the SIP message to a second gateway to deliver the SIP message to the destination UE by querying serving node information from a home subscription server (HSS).

4. The method according to claim 3, wherein the method further comprises:
receiving an indication that the destination UE is unavailable and receiving the international mobile subscriber identity (IMSI) or correlation identifier (ID) of the destination UE.

5. The method according to claim 4, wherein the method further comprises:
submitting the SMS to a short message service center (SMSC) with the IMSI or correlation ID of the destination UE.

6. An apparatus, comprising:
at least one processor; and
at least one memory comprising computer program code,
the at least one memory and the computer program code configured, with the at least one processor, to cause the apparatus at least to
send a session initiation protocol (SIP) message to an internet protocol multimedia subsystem (IMS) network where a destination user equipment (UE) is homed,
wherein the session initiation protocol (SIP) message comprises a short message service (SMS) payload, and wherein the destination user equipment (UE) does not have a mobile station international subscriber directory number (MSISDN); and
determine whether the destination user equipment (UE) is registered to the internet protocol multimedia subsystem (IMS) network.

7. The apparatus according to claim 6, wherein, when it is determined that the destination UE is IMS registered, the SIP message is delivered to the destination UE, and wherein the at least one memory and the computer program code are further configured, with the at least one processor, to cause the apparatus at least to:
receive an acknowledgement that delivery to the destination UE was successful.

8. The apparatus according to claim 6, wherein, when it is determined that the destination UE is not IMS registered, the at least one memory and the computer program code are further configured, with the at least one processor, to cause the apparatus at least to:
route the SIP message to a default gateway to deliver the SIP message to the destination UE by querying serving node information from a home subscription server (HSS).

9. The apparatus according to claim 8, wherein the at least one memory and the computer program code are further configured, with the at least one processor, to cause the apparatus at least to:
receive an indication that the destination UE is unavailable and receive the international mobile subscriber identity (IMSI) or correlation identifier (ID) of the destination UE.

10. The apparatus according to claim 9, wherein the at least one memory and the computer program code are further configured, with the at least one processor, to cause the apparatus at least to:
submit the SMS to a short message service center (SMSC) with the IMSI or correlation ID of the destination UE.

11. The apparatus according to claim 6, wherein the apparatus comprises an internet protocol short message gateway.

12. A computer program, embodied on a computer readable medium, the computer program configured to control a processor to perform a process, comprising:
sending a session initiation protocol (SIP) message to an internet protocol multimedia subsystem (IMS) network where a destination user equipment (UE) is homed,
wherein the session initiation protocol (SIP) message comprises a short message service (SMS) payload, and wherein the destination user equipment (UE) does not have a mobile station international subscriber directory number (MSISDN); and
determining whether the destination user equipment (UE) is registered to the internet protocol multimedia subsystem (IMS) network.

13. A method, comprising:
receiving, by a gateway, a session initiation protocol (SIP) message from a sending user equipment (UE) via an originating gateway,
wherein the session initiation protocol (SIP) message comprises a short message service (SMS) payload, and wherein a destination user equipment (UE) for the SMS payload does not have a mobile station international subscriber directory number (MSISDN); and
determining whether the destination user equipment (UE) is registered to the internet protocol multimedia subsystem (IMS) network.

14. The method according to claim 13, wherein, when it is determined that the destination UE is IMS registered, the SIP message is delivered to the destination UE, and the method further comprises:
sending, to the originating gateway, an acknowledgement that delivery to the destination UE was successful.

15. The method according to claim 13, wherein, when it is determined that the destination UE is not IMS registered, the method further comprises:
delivering the SIP message to the destination UE by querying serving node information from a home subscription server (HSS).

16. The method according to claim 15, further comprising:
querying the home subscription server (HSS) for the international mobile subscriber identity (IMSI) of the destination UE.

17. The method according to claim 15, further comprising:
setting a notification flag for the SMS when the destination UE becomes available.

18. The method according to claim 16, further comprising:
indicating to the HSS to store a short message service center (SMSC) address of the sending UE and an identity of the sending UE; and
sending an indication to the originating gateway that the destination UE is unavailable, wherein the indication comprises the IMSI and/or a correlation identifier (ID) of the destination UE.

19. An apparatus, comprising:
at least one processor; and
at least one memory comprising computer program code,
the at least one memory and the computer program code configured, with the at least one processor, to cause the apparatus at least to
receive a session initiation protocol (SIP) message from a sending user equipment (UE) via an originating gateway,
wherein the session initiation protocol (SIP) message comprises a short message service (SMS) payload, and wherein a destination user equipment (UE) for the SMS payload does not have a mobile station international subscriber directory number (MSISDN); and
determine whether the destination user equipment (UE) is registered to the internet protocol multimedia subsystem (IMS) network.

20. The apparatus according to claim 19, wherein, when it is determined that the destination UE is IMS registered, the SIP message is delivered to the destination UE, and the at least one memory and the computer program code are further configured, with the at least one processor, to cause the apparatus at least to:
send, to the originating gateway, an acknowledgement that delivery to the destination UE was successful.

21. The apparatus according to claim 19, wherein, when it is determined that the destination UE is not IMS registered, the at least one memory and the computer program code are further configured, with the at least one processor, to cause the apparatus at least to:
deliver the SIP message to the destination UE by querying serving node information from a home subscription server (HSS).

22. The apparatus according to claim 21, wherein the at least one memory and the computer program code are further configured, with the at least one processor, to cause the apparatus at least to:
query the home subscription server (HSS) for the international mobile subscriber identity (IMSI) of the destination UE.

23. The apparatus according to claim 21, wherein the at least one memory and the computer program code are further configured, with the at least one processor, to cause the apparatus at least to:
setting a notification flag for the SMS when the destination UE becomes available.

24. The apparatus according to claim 22, wherein the at least one memory and the computer program code are further configured, with the at least one processor, to cause the apparatus at least to:
indicate to the HSS to store a short message service center (SMSC) address of the sending UE and an identity of the sending UE; and
send an indication to the originating gateway that the destination UE is unavailable, wherein the indication comprises the IMSI and/or a correlation identifier (ID) of the destination UE.

25. The apparatus according to claim 19, wherein the apparatus comprises an internet protocol short message gateway.

26. A computer program, embodied on a computer readable medium, the computer program configured to control a processor to perform a process, comprising:
receiving a session initiation protocol (SIP) message from a sending user equipment (UE) via an originating gateway,
wherein the session initiation protocol (SIP) message comprises a short message service (SMS) payload, and wherein a destination user equipment (UE) for the SMS payload does not have a mobile station international subscriber directory number (MSISDN); and
determining whether the destination user equipment (UE) is registered to the internet protocol multimedia subsystem (IMS) network.
